(19) United States
(12) Patent Application Publication
(10) Pub. No.: US 2026/0221754 A1
(43) Pub. Date: Jul. 30, 2026

(54) ELECTRONIC FUSE CIRCUIT AND RESET CIRCUIT

(71) Applicant: PowerX Semiconductor Corporation, Hsinchu County (TW)

(72) Inventors: Kuo-Jeng WANG, Hsinchu County (TW); Wen-Ren HUANG, Hsinchu County (TW)

(21) Appl. No.: 19/254,000

(22) Filed: Jun. 30, 2025

(30) Foreign Application Priority Data
Jan. 24, 2025 (TW) 114103643

(51) Int. Cl. H02H 3/093; H02H 1/00; H02H 3/06

(52) U.S. Cl. CPC H02H 3/093; H02H 1/0061; H02H 3/06

(57) ABSTRACT

The present disclosure provides an electronic fuse circuit coupled to an output node and including a fuse switch, a charge pump circuit, a current-voltage conversion circuit and a reset circuit. The fuse switch generates an output current to the output node. The charge pump circuit is coupled to the fuse switch and a first node and controls the fuse switch according to a node voltage at the first node. The current-voltage conversion circuit is coupled to the fuse switch and a second node and converts the output current to generate a current dependent voltage at the second node. The reset circuit is coupled to the first node and the second node and, in response to the output current exceeding a current threshold, control the node voltage to trigger the charge pump circuit turning off the fuse switch after a reaction time matching the current threshold elapses.

### CROSS-REFERENCE TO RELATED APPLICATION

This application claims priority to Taiwan Application Serial Number 114103643, filed on Jan. 24, 2025, which is herein incorporated by reference in its entirety.

### BACKGROUND

### Field of Invention

This disclosure relates to an electronic fuse circuit and a reset circuit, in particular to an electronic fuse circuit and a reset circuit which are capable of operating according to a current threshold and a reaction time.

### Description of Related Art

In the related arts of an electronic fuse, the current capable of triggering the over-temperature protection of an electronic fuse is usually much higher than the current value in general applications (that is, the current threshold for the over-temperature protection is too high), which results in the electronic fuse being not turned off for protection in response to some abnormal current values lower than the current threshold but higher than the current value in general applications. When the electronic fuse is applied to the automotive system, due to the high safety requirements of the automotive system, the protection provided against the abnormal current values is important in particular. Therefore, it is necessary to propose new approaches to solve the above problems.

### SUMMARY

An aspect of present disclosure relates to an electronic fuse circuit. The electronic fuse circuit is coupled to a load device at an output node, and includes a fuse switch, a charge pump circuit, a current-voltage conversion circuit and a first reset circuit. The fuse switch is configured to receive an input voltage to generate an output voltage at the output node, and is configured to generate an output current to the output node. The charge pump circuit is coupled to the fuse switch and a first node, and is configured to control the fuse switch according to a node voltage at the first node, to control the output voltage. The current-voltage conversion circuit is coupled to the fuse switch and a second node, and is configured to convert the output current to generate a current dependent voltage at the second node. The first reset circuit is coupled to the first node and the second node, is configured to determine whether the output current exceeds a first current threshold according to the current dependent voltage, and is configured to, in response to the output current exceeding the first current threshold, control the node voltage to trigger the charge pump circuit turning off the fuse switch after a first reaction time matching the first current threshold elapses.

Another aspect of present disclosure relates to a reset circuit. The reset circuit is configured to, in response to an output current of a fuse switch exceeding a current threshold, trigger a charge pump circuit turning off the fuse switch after a reaction time matching the current threshold elapses. The reset circuit includes an overcurrent response circuit, a reaction time generation circuit and a disable circuit. The overcurrent response circuit is coupled to a current-voltage conversion circuit at a first node, and is configured to generate a first indication signal according to a current dependent voltage at the first node and a first reference voltage, wherein the first reference voltage corresponds to the current threshold, and when the output current exceeds the current threshold, the first indication signal is switched to an enable voltage level. The reaction time generation circuit is coupled to the overcurrent response circuit and a second node, and is configured to selectively adjust a charging voltage at the second node according to the first indication signal, to generate a second indication signal according to the charging voltage, wherein when the first indication signal is switched to the enable voltage level, a voltage level of the charging voltage is adjusted to a second reference voltage according to the reaction time, so that the second indication signal is switched to the enable voltage level. The disable circuit is coupled to the reaction time generation circuit, is coupled to the charge pump circuit at a third node, and is configured to switch a node voltage at the third node to a disable voltage level according to the second indication signal at the enable voltage level, so that the charge pump circuit turns off the fuse switch.

### BRIEF DESCRIPTION OF THE DRAWINGS

The present disclosure can be more fully understood by reading the following detailed description of the embodiment, with reference made to the accompanying drawings as follows:

FIG. 1 is a circuit block diagram of an electronic fuse circuit in accordance with some embodiments of the present disclosure;

FIG. 2 is a timing diagram of some signals related to an electronic fuse circuit in accordance with some embodiments of the present disclosure;

FIG. 3 is a circuit schematic diagram of an electronic fuse circuit in accordance with some embodiments of the present disclosure;

FIG. 4 is a circuit schematic diagram of an electronic fuse circuit in accordance with some embodiments of the present disclosure;

FIG. 5 is a circuit schematic diagram of an electronic fuse circuit in accordance with some embodiments of the present disclosure;

FIG. 6 is a relation curve diagram of an output current and a reaction time in accordance with some embodiments of the present disclosure;

FIG. 7 is a circuit schematic diagram of an electronic fuse circuit in accordance with some embodiments of the present disclosure;

FIG. 8 is a relation curve diagram of an output current and a reaction time in accordance with some embodiments of the present disclosure;

FIG. 9 is a circuit schematic diagram of an electronic fuse circuit in accordance with some embodiments of the present disclosure; and

FIG. 10 is a timing diagram of some signals related to an electronic fuse circuit in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

Terms used throughout the specification and the claims of the present disclosure, unless otherwise specified, generally have the ordinary meaning of each term used in the art, in the present disclosure and in special contents.

The term “coupled” or “coupled” used herein may indicate that two or more elements are in direct physical or electrical contact with each other, or that two or more elements are in indirect physical or electrical contact with each other, and also may indicate that two or more elements co-operate or interact with each other.

For clarity and convenience of descriptions, in part of the appended drawings, numerical indexes [1]-[N] are used to refer to individual components or signals, respectively, but it is not intended to limit the amount of the components or signals to a specific number. In addition, if a reference character of a component or signal is used without specifying a numerical index, it represents that the reference character can be referred to any member within a group of components or signals to which it belongs.

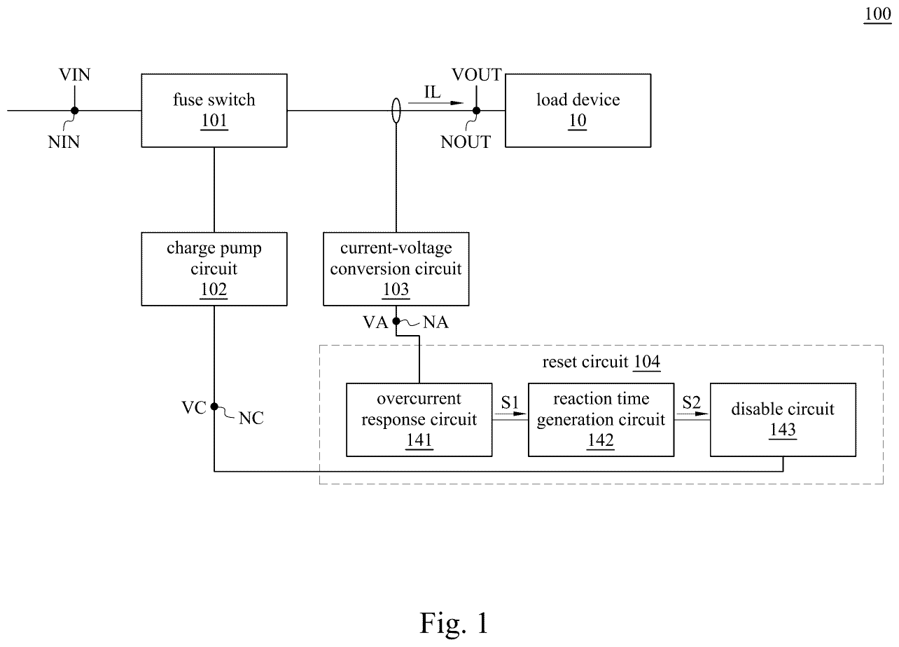

Referring to FIG. 1, FIG. 1 is a circuit block diagram of an electronic fuse circuit 100 in accordance with some embodiments of the present disclosure. In some embodiments, the electronic fuse circuit 100 is coupled to a power supply (not shown) at an input node NIN, and is coupled to a load device 10 at an output node NOUT, to provide the load device 10 with at least one of a variety of protections, such as an overcurrent protection, an overvoltage protection, an over-temperature protection, a short-circuit protection, etc., when the power supply supplies power to the load device 10.

In some embodiments, the electronic fuse circuit 100 includes a fuse switch 101, a charge pump circuit 102, a current-voltage conversion circuit 103 and a reset circuit 104. As shown in FIG. 1, the fuse switch 101 is coupled to the input node NIN to receive an input voltage VIN provided by the power supply, and is coupled to the output node NOUT to generate an output voltage VOUT at the output node NOUT. In addition, the fuse switch 101 further generates an output current IL to the output node NOUT. That is to say, the electronic fuse circuit 100 generates the output current IL and the output voltage VOUT by the fuse switch 101 receiving the input voltage VIN provided by the power supply, to supply power to the load device 10.

The charge pump circuit 102 is coupled to the fuse switch 101 and a node NC, and is configured to control the fuse switch 101 according to a node voltage VC at the node NC, to control the state of the output voltage VOUT. Specifically, the level of the output voltage VOUT can be controlled at the level of the input voltage VIN, or in a floating state. The current-voltage conversion circuit 103 is coupled to the fuse switch 101 and a node NA, and is configured to convert the output current IL to generate a current dependent voltage VA at the node NA.

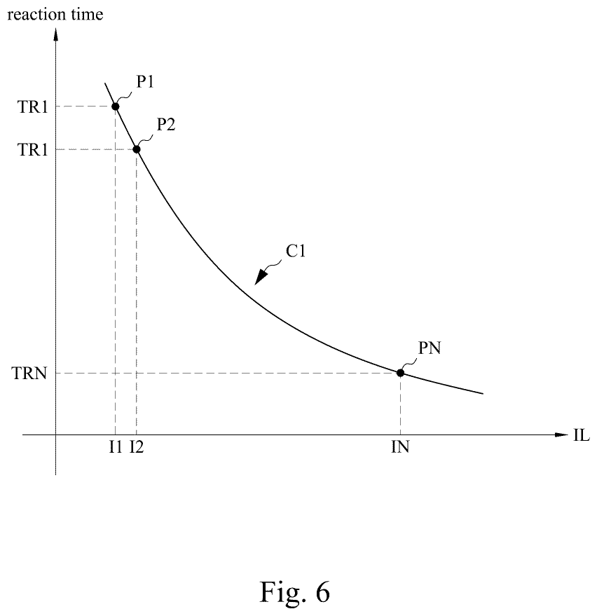

The reset circuit 104 is coupled to the node NA and the node NC. The reset circuit 104 is configured to determine whether the output current IL exceeds a current threshold according to the current dependent voltage VA, and is configured to, in response to the output current IL exceeding the current threshold, trigger the charge pump circuit 102 to turn off the fuse switch 101 after a reaction time, which matches the current threshold, elapses. In some embodiments, the current threshold and the reaction time correspond to a point on a current-time curve, which will be described in detail later with reference to FIG. 6.

From the above descriptions, the electronic fuse circuit 100 can achieve the overcurrent protection and avoid being unable to effectively react to an abnormally large load current due to the current threshold for the over-temperature protection being too high by the reset circuit 104 reacting to a specific current threshold. In addition, the electronic fuse circuit 100 can also avoid the false triggering of the over-current protection due to the inrush currents by the reset circuit 104 turning off the fuse switch 101 after the reaction time matching the current threshold elapses. Therefore, the electronic fuse circuit 100 of the present disclosure has advantages of high reliability, etc.

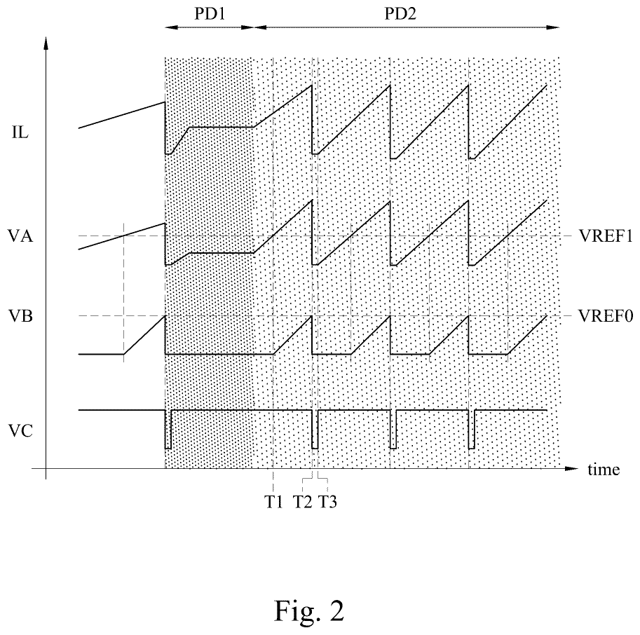

The reset circuit 104 will be further described below with reference to FIGS. 1 and 2. FIG. 2 is a timing diagram of some signals related to the electronic fuse circuit in accordance with some embodiments of the present disclosure. In the embodiment of FIG. 1, the reset circuit 104 includes an overcurrent response circuit 141, a reaction time generation circuit 142 and a disable circuit 143.

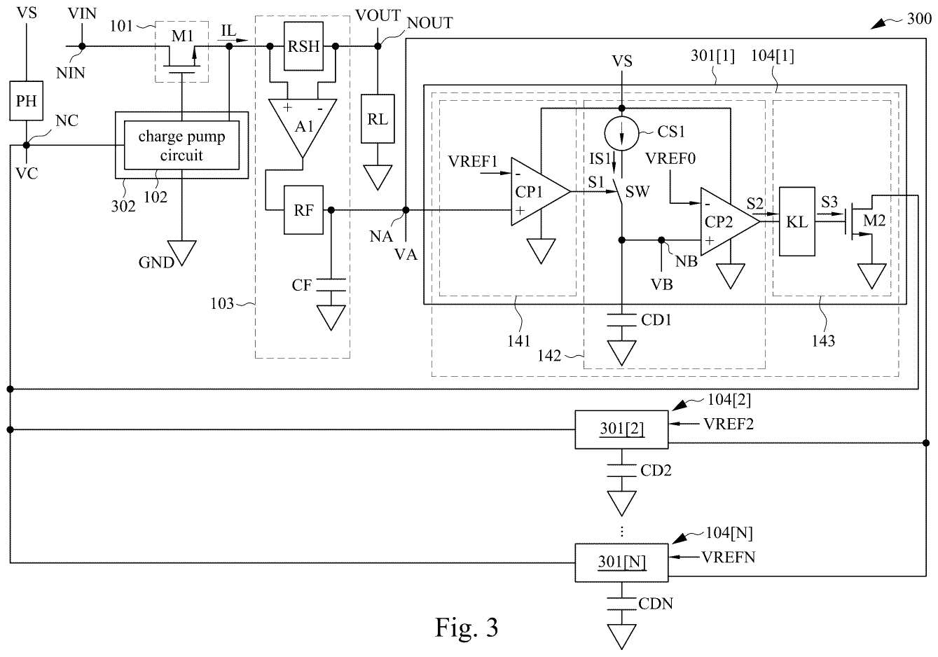

The overcurrent response circuit 141 is coupled to the node NA, and can generate an indication signal S1 according to the current dependent voltage VA and a reference voltage VREF1 shown in FIG. 2. The reaction time generation circuit 142 is coupled to the overcurrent response circuit 141, and can selectively adjust a charging voltage VB shown in FIG. 2 according to the indicating signal S1, to generate an indicating signal S2 according to the charging voltage VB. The disable circuit 143 is coupled to the reaction time generation circuit 142 and the node NC, and can switch the node voltage VC to a disable voltage level (during a period between two time points T2 and T3 in FIG. 2) according to the indication signal S2 at an enable voltage level, so that the fuse switch 101 is turned off. The operations of the overcurrent response circuit 141, the reaction time generation circuit 142 and the disable circuit 143 will be further described in the following paragraphs with reference to FIGS. 2 and 3.

FIG. 3 is a circuit schematic diagram of an electronic fuse circuit 300 in accordance with some embodiments of the present disclosure. The main difference between the electronic fuse circuit 300 of FIG. 3 and the electronic fuse circuit 100 of FIG. 1 is the number of reset circuits 104. For example, the electronic fuse circuit 100 includes one reset circuit 104, and the electronic fuse circuit 300 includes N reset circuits 104[1]-104[N].

In the embodiments of FIG. 3, the fuse switch 101 includes a transistor M1. The transistor M1 can be implemented by an N-type metal oxide semiconductor transistor, but the present disclosure is not limited thereto. As shown in FIG. 3, a first terminal (e.g., a drain terminal) of the transistor M1 can be coupled to the input node NIN and receive the input voltage VIN. A second terminal (e.g., a source terminal) of the transistor M1 can be coupled to a load resistor RL (i.e., an equivalent resistor of the load device 10 in FIG. 1) at the output node NOUT, output the output current IL to the output node NOUT and generate the output voltage VOUT at the output node NOUT. A control terminal (e.g., a gate terminal) of the transistor M1 is coupled to the charge pump circuit 102, so that the fuse switch 101 can be turned on or off by the charge pump circuit 102.

The charge pump circuit 102 can be coupled to a pull-up circuit PH at the node NC. The pull-up circuit PH can be biased by a power voltage VS to control the node voltage VC at the node NC at the enable voltage level. The charge pump circuit 102 turns on the fuse switch 101 according to the node voltage VC at the enable voltage level. In particular, the power voltage VS can be the same as the input voltage VIN, but the present disclosure is not limited thereto.

The current-voltage conversion circuit 103 includes a resistor RSH, an amplifier A1, a resistor RF and a capacitor CF. Two terminals of the resistor RSH are coupled to the second terminal of the transistor M1 and the load resistor RL, respectively. Two input terminals (i.e., a positive input terminal and a negative input terminal) of the amplifier A1 are coupled to the two terminals of the resistor RSH, respectively. Two terminals of the resistor RF are coupled to an output terminal of the amplifier A1 and the node NA, respectively. Two terminals of the capacitor CF are coupled to the node NA and the ground voltage GND, respectively. By such arrangements, the output current IL can flow to the load resistor RL through the resistor RSH, so that a voltage difference (not shown) is generated across the resistor RSH. The voltage difference is amplified by the amplifier A1 and is filtered by a filter circuit composed of the resistor RF and the capacitor CF to generate the current dependent voltage VA at the node NA. It should be understood that the voltage level of the current dependent voltage VA is in a predetermined ratio to a current level of the output current IL.

The N reset circuits 104[1]-104[N] can have the same or similar structures and operations, and thus the reset circuit 104[1] is used as an example to describe the structure and operation of each reset circuit 104.

The overcurrent response circuit 141 in the reset circuit 104[1] includes a comparator CP1. A positive input terminal (presented by “+” in the drawings) of the comparator CP1 is coupled to the node NA and receives the current dependent voltage VA. A negative input terminal (presented by “−” in the drawings) of the comparator CP1 receives the reference voltage VREF1. An output terminal of the comparator CP1 is coupled to the reaction time generation circuit 142 and outputs the indication signal S1. By such arrangements, the comparator CP1 can switch or adjust the voltage level of the indication signal S1 according to the comparison result between the current dependent voltage VA and the reference voltage VREF1. In addition, the comparator CP1 can be biased by the power voltage VS and the ground voltage GND.

It should be understood that the current dependent voltage VA and the reference voltage VREF1 correspond to the output current IL and the current threshold, respectively. That is to say, the overcurrent response circuit 141 can determine whether the output current IL exceeds the current threshold by comparing the current dependent voltage VA with the reference voltage VREF1.

The reaction time generation circuit 142 in the reset circuit 104[1] includes a current source CS1, a switch circuit SW, a capacitor CD1 and a comparator CP2. The current source CS1 can be biased by the power voltage VS to provide a charging current IS1. The switch circuit SW is coupled to the overcurrent response circuit 141, the current source CS1 and a node NB, and can be turned on or off by the indication signal S1 to selectively allow the charging current IS1 to pass. The capacitor CD1 is coupled to the node NB and the ground voltage GND, and can generate the charging voltage VB at the node NB. A positive input terminal of the comparator CP2 is coupled to the node NB, and receives the charging voltage VB. A negative input terminal of the comparator CP2 receives a reference voltage VREF0. An output terminal of the comparator CP2 is coupled to the disable circuit 143, and outputs the indication signal S2. By such arrangements, the comparator CP2 can switch or adjust the voltage level of the indication signal S2 according to the comparison result between the charging voltage VB and the reference voltage VREF0. In addition, the comparator CP2 can be biased by the power voltage VS and the ground voltage GND.

The disable circuit 143 in the reset circuit 104[1] includes a level holding circuit KL and a switch circuit. The level holding circuit KL can be implemented by a latch circuit or other suitable circuits, but the present disclosure is not limited thereto. The switch circuit can be implemented by a transistor M2 (e.g., an N-type metal oxide semiconductor transistor), but the present disclosure is not limited thereto. The level holding circuit KL is coupled to the reaction time generation circuit 142 and a control terminal of the transistor M2. A first terminal of the transistor M2 can be coupled to the node NC. A second terminal of the transistor M2 can be coupled to the ground voltage GND.

Referring to FIG. 2 again, during a period PD1, the load device 10 operates normally, and thus the output current IL is mainly maintained at a steady-state voltage level. During a period PD2 after the period PD1, the load device 10 cannot operate normally due to some non-ideal factors, and thus the output current IL starts to increase from the steady-state voltage level. Also, the current dependent voltage VA increases correspondingly according to the change of the output current IL.

At a time point T1 in the period PD2, the current dependent voltage VA exceeds the reference voltage VREF1, and thus the comparator CP1 of the overcurrent response circuit 141 switches the indication signal S1 from the disable voltage level to the enable voltage level. It should be understood that the indication signal S1 at the disable voltage level is configured to indicate that the output current IL does not exceed the current threshold, and the indication signal S1 at the enable voltage level is configured to indicate that the output current IL exceeds the current threshold.

The switch circuit SW of the reaction time generation circuit 142 is controlled by the indication signal S1 at the enable voltage level to be switched from the turn-off state to the turn-on state, so that the charging current IS1 starts to charge the capacitor CD1. As shown in FIG. 2, the charging voltage VB at the node NB starts to increase at the time point T1. At a time point T2, the charging voltage VB exceeds the reference voltage VREF0, and thus the comparator CP2 of the reaction time generation circuit 142 switches the indication signal S2 from the disable voltage level to the enable voltage level. In the embodiments of FIG. 3, the current level of the charging current IS1 is fixed and is not related to the current level of the output current IL.

The level holding circuit KL generates a switch control signal S3, which is maintained at the enable voltage level for a preset period (e.g., the period between the two time points T2 and T3 in FIG. 2), according to the indication signal S2 at the enable voltage level. The transistor M2 (i.e., the switch circuit) in the disable circuit 143 is turned on according to the switch control signal S3 at the enable voltage level to switch the node voltage VC from the enable voltage level to the ground voltage GND (which can be regarded as the disable voltage level). The charge pump circuit 102 turns off the fuse switch 101 according to the node voltage VC at the disable voltage level, so that the output current IL is greatly decreased towards a zero current level.

From FIG. 2, it can be seen that the current dependent voltage VA and the charging voltage VB are correspondingly greatly decreased in response to a large decrease in the output current IL. Notably, during the period between the two time points T2 and T3, the transistor M2 is controlled by the level holding circuit KL to remain in the turn-on state, and is not be turned off in response to a large decrease in the charging voltage VB. In such way, the electronic fuse circuit of the present disclosure can avoid the situation where the fuse switch 101 is only turned off temporarily and thus cannot effectively reduce the output current IL.

From the above descriptions, it can be seen that even if the reset circuit 104 detects that the output current IL exceeds the current threshold at time point T1, the reset circuit 104 triggers the charge pump circuit 102 to turn off the fuse switch 101 at the time point T2 by switching the node voltage VC to the disable voltage level. That is to say, the reset circuit 104 will not trigger the charge pump circuit 102 to turn off the fuse switch 101 during the period between the two time points T1 and T2. It should be understood that the time difference between the two time points T1 and T2 is the above-described reaction time matching the current threshold (which corresponds to the reference voltage VREF1). From these descriptions, it can be seen that the voltage level of the charging voltage VB is adjusted to the reference voltage VREF0 according to the reaction time, so that the indication signal S2 is switched to the enable voltage level.

Also, in some embodiments, the reset circuit 104[1] is arranged on a chip 301[1], and the current-voltage conversion circuit 103 is coupled to the reset circuit 104[1] through the chip 301[1]. In some other embodiments, part of the reset circuit 104[1] is arranged on the chip 301[1]. For example, as shown in the embodiments of FIG. 3, the components in the overcurrent response circuit 141 and the disable circuit 143 are all arranged on the chip 301[1], and the current source CS1, the switch circuit SW and the comparator CP2 of the reaction time generation circuit 142 are arranged on the chip 301[1] while the capacitor CD1 of the reaction time generation circuit 142 is arranged outside the chip 301[1]. The charge pump circuit 102 is arranged on another chip 302, and the fuse switch 101 is coupled to the charge pump circuit 102 through the chip 302.

The difference between the reset circuit 104[1] and any one of the reset circuits 104[2]-104[N] is a voltage signal which is compared with the current dependent voltage VA and a capacitance element which generates the charging voltage VB. For example, if the reset circuit 104[1] utilizes the reference voltage VREF1 and the capacitor CD1, the reset circuit 104[2] can utilize a reference voltage VREF2 greater than the reference voltage VREF1 and a capacitor CD2 having a capacitance smaller than that of the capacitor CD1. Furthermore, the reset circuit 104[N] can utilize another reference voltage VREFN greater than the reference voltage VREF2 and another capacitor CDN having a capacitance smaller than that of the capacitor CD2. It should be understood that the larger the voltage signal which is compared with the current dependent voltage VA is, the larger the set current threshold is. Also, the smaller the capacitance of the capacitor element for generating the charging voltage VB is, the shorter the set reaction time is. By such arrangements, the N reset circuits 104[1]-104[N] in FIG. 3 can define a current-time curve C1 as shown in FIG. 6 which will be described later.

In comparison to the electronic fuse circuit 100 of FIG. 1, by the N reset circuits 104[1]-104[N] reacting according to the current-time curve C1, the electronic fuse circuit 300 can apply the overcurrent protection to multiple different current abnormalities of the load device 10 with multiple different reaction times, thereby having higher reliability.

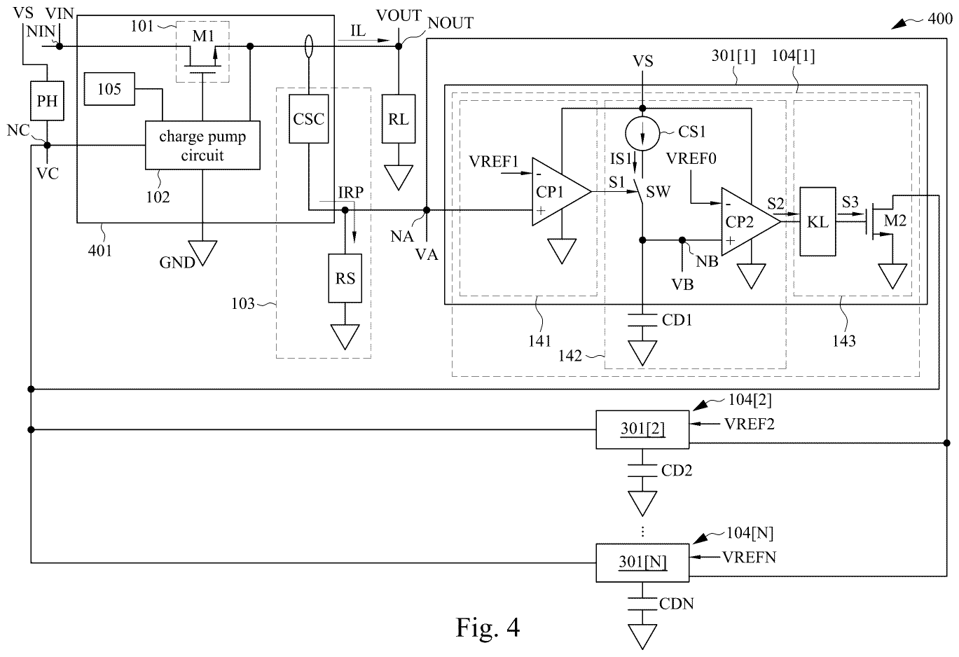

Referring to FIG. 4, FIG. 4 is a circuit schematic diagram of an electronic fuse circuit 400 in accordance with some embodiments of the present disclosure. In comparison to the electronic fuse circuit 300 in FIG. 3, the electronic fuse circuit 400 in FIG. 4 can apply the overcurrent protection to multiple different current abnormalities of the load device 10 with multiple different reaction times, and further includes an over-temperature protection circuit 105. The electronic fuse circuit 400 can achieve the over-temperature protection through the over-temperature protection circuit 105. For example, the over-temperature protection circuit 105 can detect a junction temperature of the transistor M1, and can trigger the charge pump circuit 102 turning off the fuse switch 101 when the junction temperature of the transistor M1 exceeds a temperature threshold.

In addition, referring to FIGS. 3 and 4 together, the implementation of the current-voltage conversion circuit 103 in FIG. 4 is different from the implementation of the current-voltage conversion circuit 103 in FIG. 3. In the embodiments of FIG. 4, the current-voltage conversion circuit 103 includes a current detection circuit CSC and a resistor RS. The current detection circuit CSC is coupled to the second terminal of the transistor M1 and the node NA. The resistor RS is coupled to the node NA and the ground voltage GND. During the operation of the current-voltage conversion circuit 103, the current detection circuit CSC detects the output current IL to generate a sensing current IRP in a predetermined ratio to the output current IL. In one embodiment, the current detection circuit CSC can be implemented by a current control current source (CCCS). For example, the sensing current IRP can be 1/K1 times the output current IL, where K1 can be a value greater than 1. The sensing current IRP passes through the resistor RS to generate the current dependent voltage VA at the node NA. Also, as shown in FIG. 4, the over-temperature protection circuit 105 is coupled to the charge pump circuit 102, and is arranged together with the fuse switch 101, the charge pump circuit 102 and the current detection circuit CSC of the current-voltage conversion circuit 103 on a chip 401 different from the chip 301. It can be seen that in FIG. 4, the current detection circuit CSC of the current-voltage conversion circuit 103 is arranged inside the chip 401 while the resistor RS of the current-voltage conversion circuit 103 is arranged outside the chip 401. That is, part of the current-voltage conversion circuit 103 is arranged on the chip 401.

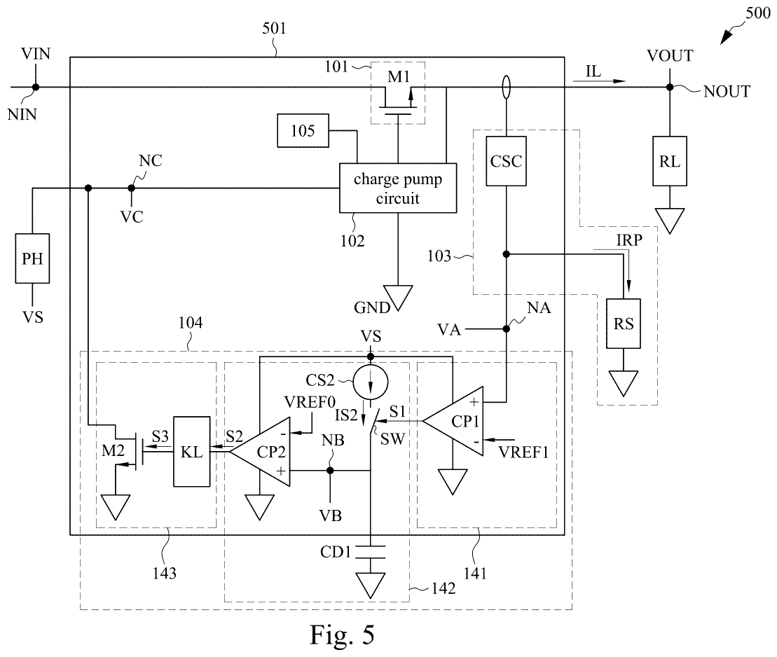

Referring to FIG. 5, FIG. 5 is a circuit schematic diagram of an electronic fuse circuit 500 in accordance with some embodiments of the present disclosure. In comparison to the electronic fuse circuit 400 of FIG. 4, the electronic fuse circuit 500 of FIG. 5 uses only one reset circuit 104 to apply the overcurrent protection to multiple different current abnormalities of the load device 10 with multiple different reaction times. In some embodiments, the fuse switch 101, the charge pump circuit 102, the current-voltage conversion circuit 103, the reset circuit 104, and the over-temperature protection circuit 105 are arranged together on a chip 501. In other embodiments, part of the reset circuit 104 and part of the current-voltage conversion circuit 103 are arranged on the chip 501. For example, in the embodiments of FIG. 5, the overcurrent response circuit 141 and the disable circuit 143 are all arranged on the chip 501, the current source CS2, the switch circuit SW and the comparator CP2 of the reaction time generation circuit 142 are arranged on the chip 501, and the capacitor CD1 of the reaction time generation circuit 142 is arranged outside the chip 501. In addition, the current detection circuit CSC of the current-voltage conversion circuit 103 is arranged on the chip 501, and the resistor RS of the current-voltage conversion circuit 103 is arranged outside the chip 501.

In the embodiments of FIG. 5, the reaction time generation circuit 142 in the reset circuit 104 utilizes a current source CS2 to replace the current source CS1 utilizes in the embodiments of FIG. 3 or 4. Notably, a charging current IS2 provided by the current source CS2 is in a predetermined ratio to the output current IL. For example, the charging current IS2 can be K2/K1 times the output current IL, where K2 may be a fixed constant. In particular, the larger the output current IL is, the larger the charging current IS2 is. Furthermore, the larger the charging current IS2 for generating the charging voltage VB is, the shorter the set reaction time is. By such arrangements, the single reset circuit 104 of FIG. 5 can also define the current-time curve C1 as shown in FIG. 6 described later.

From the embodiments of FIGS. 3, 4 and 5, the electronic fuse circuits 300, 400 and 500 can all apply the overcurrent protection to multiple different current abnormalities of the load device 10 with multiple different reaction times by the current-time curve C1. Referring to FIG. 6, FIG. 6 is a schematic diagram of the current-time curve C1 in accordance with some embodiments of the present disclosure.

In FIG. 6, a point P1 of the current-time curve C1 is defined by the current threshold of a current value I1 and the reaction time of a time length TR1, where the current value I1 and the time length TR1 can correspond to the reference voltage VREF1 and the capacitance value of the capacitor CD1 in the embodiments of FIG. 3 or 4, respectively. A point P2 of the current-time curve C1 is defined by the current threshold of a current value I2 and the reaction time of a time length TR2, where the current value I2 and the time length TR2 can correspond to the reference voltage VREF2 and the capacitance value of the capacitor CD2 in the embodiments of FIG. 3 or 4, respectively. Also, a point PN of the current-time curve C1 is defined by the current threshold of a current value IN and the reaction time of a time length TRN, where the current value IN and the time length TRN can correspond to the reference voltage VREFN and the capacitance value of the capacitor CDN in the embodiments of FIG. 3 or 4, respectively.

It should be understood that the charging current IS2 provided by the current source CS2 in FIG. 5 will also have multiple different current levels according to the change of the output current IL (e.g., the current value I1, the current value I2, the current value IN, etc.) to correspond to multiple different reaction times (e.g., the length TR1, the length TR2, the length TRN, etc.).

From the above descriptions, it can be seen that when the current threshold corresponding to the reference voltage VREFN (i.e., the current value IN) is greater than the current threshold corresponding to the reference voltage VREF1 (i.e., the current value I1), the reaction time corresponding to the capacitor CDN (i.e., the time length TRN) is shorter than the reaction time corresponding to the capacitor CD1 (i.e., the time length TR1). From another perspective, when the current threshold corresponding to the reference voltage VREF1 (i.e., the current value I1) is less than the current threshold corresponding to the reference voltage VREFN (i.e., the current value IN), the reaction time corresponding to the capacitor CD1 (i.e., the time length TR1) is longer than the reaction time corresponding to the capacitor CDN (i.e., the time length TRN).

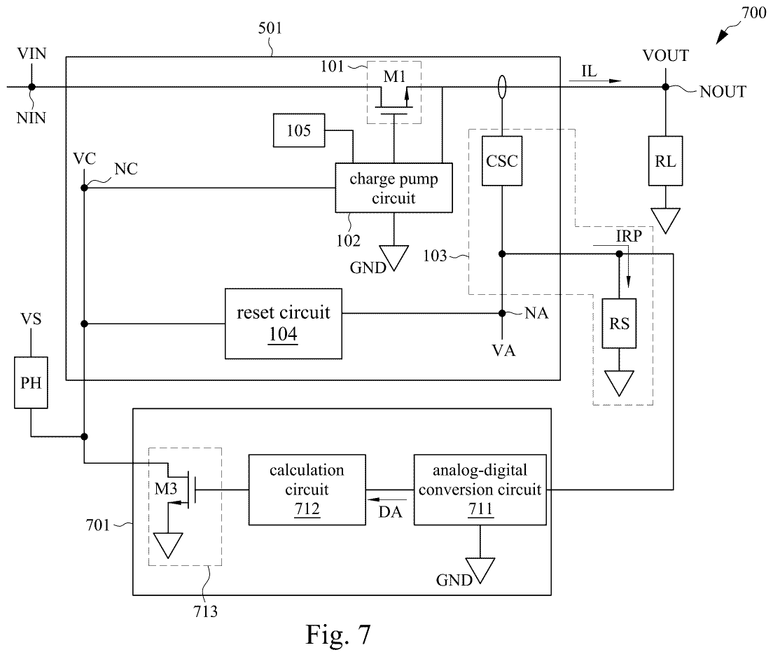

Referring to FIG. 7, FIG. 7 is a circuit schematic diagram of an electronic fuse circuit 700 in accordance with some embodiments of the present disclosure. In comparison to the electronic fuse circuit 500 in FIG. 5, the electronic fuse circuit 700 of FIG. 7 further includes a control circuit 701. The control circuit 701 is coupled to the node NA and the node NC, and includes an analog-digital conversion circuit 711, a calculation circuit 712, and a switch circuit 713. The analog-digital conversion circuit 711 is coupled to the node NA, the calculation circuit 712 is coupled to the analog-digital conversion circuit 711, and the switch circuit 713 is coupled to the node NC. The control circuit 701 can be implemented by a microcontroller (MCU). The analog-digital conversion circuit 711 can be implemented by an analog-to-digital converter (ADC). The calculation circuit 712 can be implemented by a central processing unit (CPU). The switch circuit 713 can be implemented by a transistor M3 (e.g., an N-type metal oxide semiconductor transistor). The implementation of the control circuit 701 of the present disclosure is not limited to the above. A control terminal of the transistor M3 can be coupled to the calculation circuit 712. A first terminal of the transistor M3 can be coupled to the node NC. A second terminal of the transistor M3 can be coupled to the ground voltage GND.

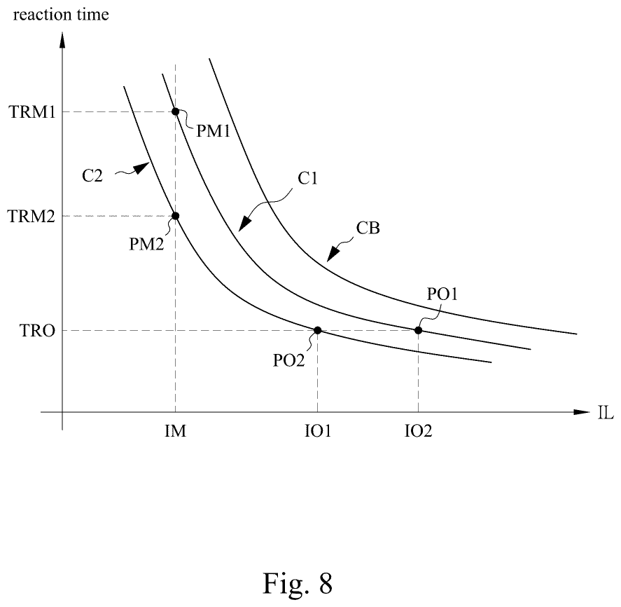

The operations of the control circuit 701 will be described with reference to FIGS. 7 and 8. FIG. 8 is a schematic diagram of the relationship among current-time curves C1, C2, and CB in accordance with some embodiments of the present disclosure.

In some embodiments, the analog-digital conversion circuit 711 receives the current dependent voltage VA from the node NA, and performs an analog-to-digital conversion on the current dependent voltage VA to generate a digital voltage DA. The calculation circuit 712 receives the digital voltage DA, and determines whether the output current IL exceeds one of multiple current thresholds defined by the current-time curve C2 (e.g., a current value IM in FIG. 8) according to the digital voltage DA. When determining that the output current IL exceeds one of the current thresholds defined by the current-time curve C2, the calculation circuit 712 starts timing and determines whether one of multiple reaction times matching one of the current thresholds (e.g., a time length TRM2 in FIG. 8) elapses. When determining that one of the reaction times matching one of the current thresholds elapses, the calculation circuit 712 turns on the switch circuit 713 by controlling the voltage at the control terminal of the transistor M3 to the enable voltage level. Accordingly, the node voltage VC at the node NC is switched to the disable voltage level (i.e., the ground voltage GND), so that the charge pump circuit 102 turns off the fuse switch 101.

From the above descriptions, it can be seen that the control circuit 701 can determine whether the output current IL exceeds any current threshold defined by the current-time curve C2 according to the current dependent voltage VA, and can, in response to the output current IL exceeding any current threshold defined by the current-time curve C2, trigger the charge pump circuit 102 turning off the fuse switch 101 after the reaction time matching any current threshold defined by the current-time curve C2 elapses.

From the descriptions of FIG. 8, it can be seen that when the current threshold utilized by the reset circuit 104 (e.g., the current value IM corresponding to point PM1) is the same as that of the control circuit 701 (e.g., the current value IM corresponding to point PM2), the reaction time utilized by the control circuit 701 (i.e., the time length TRM2 corresponding to point PM2) is shorter than that of the reset circuit 104 (i.e. the time length TRM1 corresponding to point PM1). From another perspective, when the reaction time utilized by the control circuit 701 (e.g., the time length TRO corresponding to the point PO2) is the same as that of the reset circuit 104 (e.g., the time length TRO corresponding to the point PO1), the current threshold utilized by the reset circuit 104 (i.e., the current value IO1 corresponding to the point PO1) is greater than that of the control circuit 701 (i.e., the current value IO2 corresponding to the point PO2).

In addition, in FIG. 8, the current-time curve CB represents the critical ignition boundary of the wiring harness connected to the power distribution module to which the electronic fuse circuit 700 is applied. For example, when the output current IL exceeds any current threshold defined by the current-time curve CB, the wiring harness in the circuit may start to burn if the output current IL is not reduced to the zero current level within the corresponding reaction time, thereby causing damages to the circuit. Therefore, in FIG. 8, the current-time curves C1 and C2 are set to the left of the current-time curve CB.

In accordance with the above descriptions, in FIG. 8, the current-time curve C2 is set to the left of the current-time curve C1. In such way, the electronic fuse circuit 700 can still achieve the overcurrent protection through the reset circuit 104 when the control circuit 701 malfunctions.

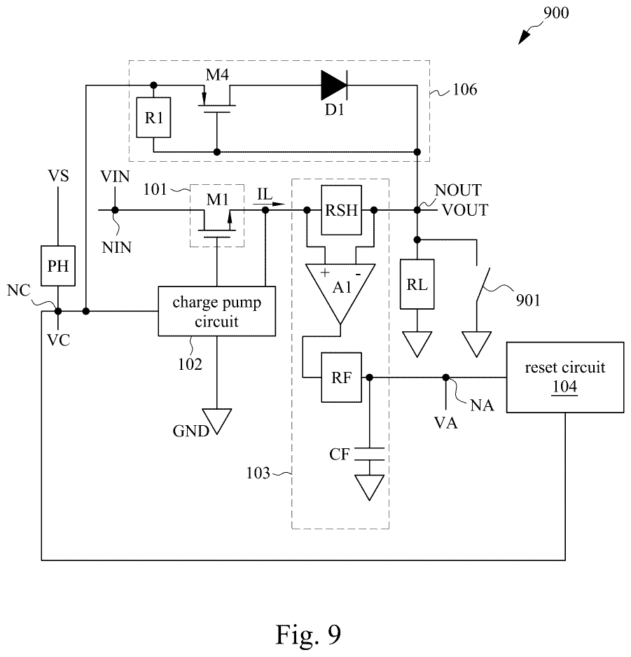

Referring to FIG. 9, FIG. 9 is a circuit schematic diagram of an electronic fuse circuit 900 in accordance with some embodiments of the present disclosure. In comparison to the electronic fuse circuit 300 in FIG. 3, the electronic fuse circuit 900 in FIG. 9 further includes a short-circuit protection circuit 106, to achieve the short-circuit protection through the short-circuit protection circuit 106. The short-circuit protection circuit 106 can be coupled to the output node NOUT and the node NC of FIG. 1.

As shown in FIG. 9, the short-circuit protection circuit 106 includes a diode D1, a resistor R1 and a transistor M4. A control terminal of the transistor M4 can be coupled to the load resistor RL at the output node NOUT. A first terminal of the transistor M4 can be coupled to an anode terminal of the diode D1. A second terminal of the transistor M4 can be coupled to the node NC. Two terminals of the resistor R1 are coupled to the second terminal and the control terminal of the transistor M4, respectively. A cathode terminal of the diode D1 can be coupled to the load resistor RL at the output node NOUT. The transistor M4 can be implemented by a P-type metal oxide semiconductor transistor, the diode D1 can be implemented by a Schottky diode, but the present disclosure is not limited thereto. As shown in FIG. 9, the electronic fuse circuit 900 further includes a switch 901, and the switch 901 is coupled to the output node NOUT and the ground voltage GND.

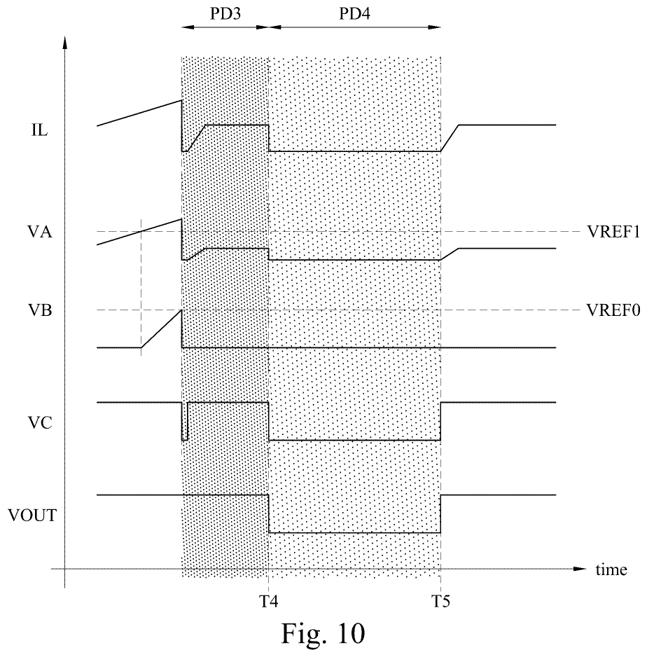

The operations of the short-circuit protection circuit 106 will be described with reference to FIGS. 9 and 10. FIG. 10 is a timing diagram of some signals related to the electronic fuse circuit 900 in accordance with some embodiments of the present disclosure.

As shown in FIG. 10, during a period PD3, the load device 10 operates normally, so that the output voltage VOUT is maintained at the steady-state voltage level. During a period PD4 after the period PD3, the electronic fuse circuit 900 is operated in a safety test mode related to an output-to-ground short-circuit protection (SCP). In the safety test mode, the switch 901 is turned on, so that a short-circuit event occurs at the output node NOUT. Therefore, at a time point T4, the output voltage VOUT is switched to, for example the ground voltage GND. In the embodiments of FIG. 9, at the beginning of the output voltage VOUT being switched to the ground voltage GND, the node voltage VC at the node NC is still at the enable voltage level. Accordingly, a voltage difference (not shown) is generated across the resistor R1 and causes the transistor M4 to be turned on. After the transistor M4 is turned on, the node voltage VC at the node NC is switched to the ground voltage GND or a voltage level close to the ground voltage GND (as shown in FIG. 10) due to the limitation of the on-state diode D1, such that the charge pump circuit 102 turns off the fuse switch 101. It should be understood that the output current IL, the current dependent voltage VA and the charging voltage VB will change correspondingly after the fuse switch 101 is turned off. In brief, the short-circuit protection circuit 106 is configured to switch the node voltage VC to the disable voltage level in the safety test mode (i.e., when the output voltage VOUT is switched to the ground voltage GND), so that the fuse switch 101 is turned off, thereby achieving the output-to-ground protection.

At a time point T5, the switch 901 is turned off, so that the short-circuit event at the output node NOUT disappears. The output voltage VOUT is restored to the steady-state voltage level, so that the short-circuit protection circuit 106 turns off the transistor M4 and the diode D1. Then, the node voltage VC at the node NC is switched to the enable voltage level through the pull-up circuit PH, so that the charge pump circuit 102 turns on the fuse switch 101. Therefore, the output current IL and the current dependent voltage VA will change correspondingly. In the embodiments of FIG. 10, the charging voltage VB is maintained at, for example the ground voltage GND, because the current dependent voltage VA does not exceed the reference voltage VREF1.

In another embodiment, the resistor R1 and the transistor M4 are omitted from the short-circuit protection circuit 106. In this case, the anode terminal of the diode D1 is directly connected to the node NC, and the cathode terminal of the diode D1 is directly connected to the output node NOUT. When the electronic fuse circuit 900 is in the safety test mode, the switch 901 is turned on, so that the short-circuit event occurs at the output node NOUT. Therefore, the output voltage VOUT is switched to the ground voltage GND. At the beginning of the output voltage VOUT being switched to the ground voltage GND, the node voltage VC at the node NC is still at the enable voltage level. At this time, the diode D1 is turned on based on the voltage difference between the node voltage VC and the output voltage VOUT. The node voltage VC is switched to the ground voltage GND or the voltage level close to the ground voltage GND (as shown in FIG. 10) due to the limitation of the on-state diode D1, such that the charge pump circuit 102 turns off the fuse switch 101. In brief, the short-circuit protection circuit 106 is configured to switch the node voltage VC to the disable voltage level in the safety test mode, so that the fuse switch 101 is turned off, thereby achieving the output-to-ground protection. When the switch 901 is turned off, the short-circuit event at the output node NOUT disappears. The output voltage VOUT is restored to the steady-state voltage level, so that the diode D1 is turned off. Then, the node voltage VC at the node NC is switched to the enable voltage level through the pull-up circuit PH, so that the charge pump circuit 102 turns on the fuse switch 101. According to this embodiment, when the electronic fuse circuit 900 enters the safety test mode, the charge pump circuit 102 can turn off the fuse switch 101 faster.

According to the above descriptions, the electronic fuse circuit proposed by the present disclosure achieves both the overcurrent protection and the output-to-ground short-circuit protection, thereby improving the safety and reliability of the electronic fuse circuit. In particular, when the electronic fuse circuit proposed by the present disclosure is applied to an automotive power distribution module, the electronic fuse circuit can turn off the fuse switch by the overcurrent protection or the output-to-ground short-circuit protection when an abnormality (e.g., the excessive load current) occurs or when entering a specific mode (e.g., the safety test mode), so as to prevent the wiring harness connected to the power distribution module from burning.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. An electronic fuse circuit, coupled to a load device at an output node, and comprising:
a fuse switch, configured to receive an input voltage to generate an output voltage at the output node, and configured to generate an output current to the output node;
a charge pump circuit, coupled to the fuse switch and a first node, and configured to control the fuse switch according to a node voltage at the first node, to control the output voltage;
a current-voltage conversion circuit, coupled to the fuse switch and a second node, and configured to convert the output current to generate a current dependent voltage at the second node; and
a first reset circuit, coupled to the first node and the second node, configured to determine whether the output current exceeds a first current threshold according to the current dependent voltage, and configured to, in response to the output current exceeding the first current threshold, control the node voltage to trigger the charge pump circuit turning off the fuse switch after a first reaction time matching the first current threshold elapses.

2. The electronic fuse circuit of claim 1, wherein the first reset circuit comprises:
an overcurrent response circuit, coupled to the second node, and configured to generate a first indication signal according to the current dependent voltage and a first reference voltage, wherein the first reference voltage corresponds to the first current threshold, and when the output current exceeds the first current threshold, the first indication signal is switched to an enable voltage level;
a reaction time generation circuit, coupled to the overcurrent response circuit and a third node, and configured to selectively adjust a charging voltage at the third node according to the first indication signal, to generate a second indication signal according to the charging voltage, wherein when the first indication signal is switched to the enable voltage level, a voltage level of the charging voltage is adjusted to a second reference voltage according to the first reaction time, so that the second indication signal is switched to the enable voltage level; and
a disable circuit, coupled to the reaction time generation circuit and the first node, and configured to switch the node voltage to a disable voltage level according to the second indication signal at the enable voltage level, so that the charge pump circuit turns off the fuse switch.

3. The electronic fuse circuit of claim 2, wherein the overcurrent response circuit comprises:
a comparator, wherein a positive input terminal of the comparator is coupled to the second node and configured to receive the current dependent voltage, a negative input terminal of the comparator is configured to receive the first reference voltage, and an output terminal of the comparator is coupled to the reaction time generation circuit and configured to output the first indication signal.

4. The electronic fuse circuit of claim 2, wherein the reaction time generation circuit comprises:
a current source, configured to provide a charging current;
a switch circuit, coupled to the overcurrent response circuit, the current source and the third node, and configured to be turned on or off by the first indication signal, to selectively allow the charging current to pass;
a capacitor, coupled to the third node and a ground voltage, and configured to generate the charging voltage at the third node; and
a comparator, wherein a positive input terminal of the comparator is coupled to the third node and configured to receive the charging voltage, a negative input terminal of the comparator is configured to receive the second reference voltage, and an output terminal of the comparator is coupled to the disable circuit and configured to output the second indication signal.

5. The electronic fuse circuit of claim 4, wherein a current level of the charging current is fixed or is in a predetermined ratio to a current level of the output current.

6. The electronic fuse circuit of claim 2, wherein the disable circuit comprises:
a level holding circuit, coupled to the reaction time generation circuit, and configured to generate a switch control signal which is maintained at the enable voltage level for a preset period according to the second indication signal at the enable voltage level; and
a switch circuit, coupled to the level holding circuit, the first node and a ground voltage, and is configured to be turned on according to the switch control signal at the enable voltage level, to switch the node voltage to the disable voltage level.

7. The electronic fuse circuit of claim 1, wherein part of the first reset circuit is arranged on a first chip, the current-voltage conversion circuit is coupled to the first reset circuit through the first chip, the charge pump circuit is arranged on a second chip, and the fuse switch is coupled to the charge pump circuit through the second chip.

8. The electronic fuse circuit of claim 7, further comprising:
a short-circuit protection circuit, coupled to the output node and the first node, and configured to switch the node voltage to a disable voltage level when the output voltage is switched to a ground voltage, so that the fuse switch is turned off.

9. The electronic fuse circuit of claim 1, wherein part of the first reset circuit is arranged on a first chip, and the fuse switch, the charge pump circuit and the current-voltage conversion circuit are arranged on a second chip.

10. The electronic fuse circuit of claim 1, wherein the fuse switch, the charge pump circuit, part of the current-voltage conversion circuit and part of the first reset circuit are arranged on a first chip.

11. The electronic fuse circuit of claim 1, further comprising:
a second reset circuit, coupled to the first node and the second node, configured to determine whether the output current exceeds a second current threshold according to the current dependent voltage, and configured to, in response to the output current exceeding the second current threshold, trigger the charge pump circuit turning off the fuse switch after a second reaction time matching the second current threshold elapses,
wherein the first current threshold and the first reaction time correspond to a first point on a first current-time curve, and the second current threshold and the second reaction time correspond to a second point on the first current-time curve.

12. The electronic fuse circuit of claim 11, wherein when the second current threshold is greater than the first current threshold, the second reaction time is shorter than the first reaction time, and when the second current threshold is less than the first current threshold, the second reaction time is longer than the first reaction time.

13. The electronic fuse circuit of claim 1, further comprising:
a control circuit, coupled to the first node and the second node, configured to determine whether the output current exceeds a third current threshold according to the current dependent voltage, and configured to, in response to the output current exceeding the third current threshold, trigger the charge pump circuit turning off the fuse switch after a third reaction time matching the third current threshold,
wherein the third current threshold and the third reaction time correspond to a first point of a second current-time curve.

14. The electronic fuse circuit of claim 13, wherein when the first current threshold and the third current threshold are identical, the third reaction time is shorter than the first reaction time, and when the first reaction time and the third reaction time are identical, the first current threshold is greater than the third current threshold.

15. A reset circuit, configured to, in response to an output current of a fuse switch exceeding a current threshold, trigger a charge pump circuit turning off the fuse switch after a reaction time matching the current threshold elapses, and comprising:
an overcurrent response circuit, coupled to a current-voltage conversion circuit at a first node, and configured to generate a first indication signal according to a current dependent voltage at the first node and a first reference voltage, wherein the first reference voltage corresponds to the current threshold, and when the output current exceeds the current threshold, the first indication signal is switched to an enable voltage level;
a reaction time generation circuit, coupled to the overcurrent response circuit and a second node, and configured to selectively adjust a charging voltage at the second node according to the first indication signal, to generate a second indication signal according to the charging voltage, wherein when the first indication signal is switched to the enable voltage level, a voltage level of the charging voltage is adjusted to a second reference voltage according to the reaction time, so that the second indication signal is switched to the enable voltage level; and
a disable circuit, coupled to the reaction time generation circuit, coupled to the charge pump circuit at a third node, and configured to switch a node voltage at the third node to a disable voltage level according to the second indication signal at the enable voltage level, so that the charge pump circuit turns off the fuse switch.

16. The reset circuit of claim 15, wherein the overcurrent response circuit comprises:
a comparator, wherein a positive input terminal of the comparator is coupled to the first node and configured to receive the current dependent voltage, a negative input terminal of the comparator is configured to receive the first reference voltage, and an output terminal of the comparator is coupled to the reaction time generation circuit and configured to output the first indication signal.

17. The reset circuit of claim 15, wherein the reaction time generation circuit comprises:
a current source, configured to provide a charging current;
a switch circuit, coupled to the overcurrent response circuit, the current source and the second node, and configured to be turned on or off by the first indication signal, to selectively allow the charging current to pass;
a capacitor, coupled to the second node and a ground voltage, and configured to generate the charging voltage at the second node; and
a comparator, wherein a positive input terminal of the comparator is coupled to the second node and configured to receive the charging voltage, a negative input terminal of the comparator is configured to receive the second reference voltage, and an output terminal of the comparator is coupled to the disable circuit and configured to output the second indication signal.

18. The reset circuit of claim 17, wherein a current level of the charging current is fixed.

19. The reset circuit of claim 17, wherein a current level of the charging current is in a predetermined ratio to a current level of the output current.

20. The reset circuit of claim 15, wherein the disable circuit comprises:
a level holding circuit, coupled to the reaction time generation circuit, and configured to generate a switch control signal which is maintained at the enable voltage level for a preset period according to the second indication signal at the enable voltage level; and
a switch circuit, coupled to the level holding circuit, the third node and a ground voltage, and is configured to be turned on according to the switch control signal at the enable voltage level, to switch the node voltage to the disable voltage level.
